(19) United States
(12) Patent Application Publication
(10) Pub. No.: US 2026/0189064 A1
(43) Pub. Date: Jul. 2, 2026

(54) HOME ENERGY MANAGEMENT SYSTEM AND METHOD

(71) Applicant: Volvo Car Corporation, Göteborg (SE)

(72) Inventors: Basavaprabhu Mundas, Göteborg (SE); Ali Fotouhi, Göteborg (SE)

(21) Appl. No.: 19/004,624

(22) Filed: Dec. 30, 2024

(51) Int. Cl. H02J 13/00; H02J 3/00; H02J 3/14; H02J 3/32

(52) U.S. Cl. CPC H02J 13/14; H02J 3/003; H02J 3/14; H02J 3/322; H02J 2103/30; H02J 2105/42

(57) ABSTRACT

A home energy management system and method utilizing one or more processors and one or more memories storing instructions executed by the one or more processors to receive collective energy usage data including home energy usage data and electric vehicle energy usage data, extract the electric vehicle energy usage data from the collective energy usage data to determine the home energy usage data, and control energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of the home energy management system. In some embodiments, the electric vehicle energy usage data is extracted from the collective energy usage data using Ensembled Empirical Model Decomposition and a Hilbert-Huang Transform.

### TECHNICAL FIELD

The present disclosure relates generally to the home energy management and electric vehicle (EV) charging fields. More particularly, the present disclosure relates to a home energy management system (EMS) and method for users with an EV that utilize ensembled empirical model decomposition to extract information about an EV charging cycle from collective data related to the electricity consumption of a home.

### BACKGROUND

Given the tremendous rise in EV charging in the home, it is desirable to enable a home EMS and method that provide a versatile home energy management platform with the capability to seamlessly integrate the bidirectional charging of an EV within an optimization framework. The goal is to enable users to achieve specific user-defined objectives, such as cost minimization, the maximization of renewable self-consumption, and/or the minimization of emissions. Preferably, the home EMS and method are engineered to cater to the conditions of a single home and a single charging cycle. This primary functionality empowers users to select distinct objective functions, namely the cost minimization aimed at reducing overall energy consumption expenses and/or the maximization of renewable self-consumption aimed at facilitating the efficient utilization of renewable energy generated within the home.

One problem in achieving such goals is that available home electricity consumption data used by such a home EMS and method typically includes the collective hourly electricity readings of an EV and a home, unless inefficient sub-metering is provided. The same may be true for heat pump use and the like. In such cases, it is desirable to operate the home EMS and method with a forecast for the home alone, without the effect of the EV charging, heat pump, etc. In other words, it is desirable to distinguish between inflexible household loads and variable household loads, such as EV charging and heat pumps, where identifying inflexible household loads provides a better understanding of the baseline power consumption of the household. Thus, what is needed is a home EMS and method that operate locally or remotely to extract such EV charging data, heat pump data, and the like from the collective hourly electricity readings, without sub-metering.

The present background is provided only as illustrative environmental context and should not be construed to be limiting in any respect. It will be readily apparent to those of ordinary skill in the art that the principles and concepts of the present disclosure can be implemented in other environmental contexts equally.

### SUMMARY

The present disclosure provides such a home EMS and method that operate locally or remotely to extract such historical EV charging data from the historical collective hourly electricity readings of a home, without sub-metering in the home or at an EV charger, for example. This extraction can be performed at the EMS locally, remotely in the cloud coupled to the EMS, or as part of an electricity usage forecasting model implemented in the EMS. Using the resulting home hourly electricity usage forecast data with the EV charging data removed, the EMS and method may then be operated to achieve the user goals of cost minimization aimed at reducing overall energy consumption expenses and/or maximization of renewable self-consumption aimed at facilitating the efficient utilization of renewable energy generated within a home, catering to the conditions of a single home and a single charging cycle. It should be noted that, more specifically, the EV charger is EV supply equipment (EVSE), which may be unidirectional or bidirectional.

The home EMS and method utilize ensembled empirical model decomposition to extract the information about the EV charging cycle from the collective data related to the electricity consumption of the home. In this manner, historical EV loads can be extracted from historical non-EV loads, such that the home EMS and method can be operated with the historical non-EV load data, without the need for EV sub-metering, for example.

In some embodiments, the present disclosure provides a home energy management system including one or more processors and one or more memories storing instructions executed by the one or more processors to receive collective energy usage data including home energy usage data and electric vehicle energy usage data, extract the electric vehicle energy usage data from the collective energy usage data to determine the home energy usage data, and control energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of the home energy management system. In some embodiments, the electric vehicle energy usage data is extracted from the collective energy usage data using Ensembled Empirical Model Decomposition. In some embodiments, the electric vehicle energy usage data is further extracted from the collective energy usage data using a Hilbert-Huang Transform. In some embodiments, the electric vehicle energy usage data is further extracted from the collective energy usage by decomposing a signal into a set of Intrinsic Mode Functions that are simple oscillatory modes that represent different frequency components of the signal and removing the Intrinsic Mode Functions from the collective energy usage data to determine the home energy usage data. The one or more processors and the one or more memories are disposed in one or more of the home energy management system, a cloud network, and a model generator for the home energy management system. In some embodiments, the electric vehicle supply equipment is a bidirectional electric vehicle charger.

In some embodiments, the present disclosure provides a home energy management method includes receiving collective energy usage data including home energy usage data and electric vehicle energy usage data, extracting the electric vehicle energy usage data from the collective energy usage data to determine the home energy usage data, and controlling energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of the home energy management system. In some embodiments, the electric vehicle energy usage data is extracted from the collective energy usage data using Ensembled Empirical Model Decomposition. In some embodiments, the electric vehicle energy usage data is further extracted from the collective energy usage data using a Hilbert-Huang Transform. In some embodiments, the electric vehicle energy usage data is further extracted from the collective energy usage by decomposing a signal into a set of Intrinsic Mode Functions that are simple oscillatory modes that represent different frequency components of the signal and removing the Intrinsic Mode Functions from the collective energy usage data to determine the home energy usage data. In some embodiments, the electric vehicle supply equipment is a bidirectional electric vehicle charger.

In some embodiments, the present disclosure provides a non-transitory computer-readable medium including instructions stored in one or more memories storing instructions executed by the one and executed by or more processors to receive collective energy usage data including home energy usage data and electric vehicle energy usage data, extract the electric vehicle energy usage data from the collective energy usage data to determine the home energy usage data, and control energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of a home energy management system. In some embodiments, the electric vehicle energy usage data is extracted from the collective energy usage data using Ensembled Empirical Model Decomposition. In some embodiments, the electric vehicle energy usage data is further extracted from the collective energy usage data using a Hilbert-Huang Transform. In some embodiments, the electric vehicle energy usage data is further extracted from the collective energy usage by decomposing a signal into a set of Intrinsic Mode Functions that are simple oscillatory modes that represent different frequency components of the signal and removing the Intrinsic Mode Functions from the collective energy usage data to determine the home energy usage data. The one or more processors and the one or more memories are disposed in one or more of the home energy management system, a cloud network, and a model generator for the home energy management system. In some embodiments, the electric vehicle supply equipment is a bidirectional electric vehicle charger.

It will be readily apparent to those of ordinary skill in the art that features and aspects of the various described embodiments of the present disclosure may be included, omitted, or combined as desired in a given application, without limitation.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 illustrates one embodiment of the home EMS and method of the present disclosure, highlighting the associated inputs;

FIG. 2 illustrates data divided into nine Intrinsic Mode Functions (IMFs) using Ensemble Empirical Mode Decomposition (EEMD) in accordance with the present disclosure;

FIG. 3 illustrates the nine IMFs in a frequency domain in accordance with the present disclosure;

FIG. 4 illustrates a comparison of actual EV consumption and a reconstructed signal using the EEMD in accordance with the present disclosure;

FIG. 5 illustrates the actual total EV consumption per month;

FIG. 6 illustrates the total of the removed IMFs per month in accordance with the present disclosure;

FIG. 7 illustrates the dataset of the total home consumption;

FIG. 8 illustrates the dataset of the total home consumption with the IMFs removed in accordance with the present disclosure;

FIG. 9 is a network diagram of a cloud-based system for implementing the various algorithms and functions of the present disclosure;

FIG. 10 is a block diagram of a server that may be used in the cloud-based system of FIG. 9 or stand-alone; and

FIG. 11 is a block diagram of a user device that may be used in the cloud-based system of FIG. 9 or stand-alone.

It will be readily apparent to those of ordinary skill in the art that features and aspects of the various illustrated embodiments of the present disclosure may be included, omitted, or combined as desired in a given application, without limitation.

### DETAILED DESCRIPTION

Again, the present disclosure provides a home EMS and method that operate locally or remotely to extract such historical EV charging data from the historical collective hourly electricity readings of a home, without sub-metering in the home or at an EV charger, for example. This extraction can be performed at the EMS locally, remotely in the cloud coupled to the EMS, or as part of an electricity usage forecasting model implemented in the EMS. The present disclosure allows a user to distinguish between inflexible household loads and variable household loads, such as EV charging and heat pumps, where identifying inflexible household loads provides a better understanding of the baseline power consumption of the household. Using the resulting home hourly electricity usage forecast data with the EV charging data removed, the EMS and method may then be operated to achieve the user goals of cost minimization aimed at reducing overall energy consumption expenses and/or maximization of renewable self-consumption aimed at facilitating the efficient utilization of renewable energy generated within a home, catering to the conditions of a single home and a single charging cycle.

The home EMS and method utilize ensembled empirical model decomposition to extract the information about the EV charging cycle from the collective data related to the electricity consumption of the home. In this manner, historical EV loads can be extracted from historical non-EV loads, such that the home EMS and method can be operated with the historical non-EV load data, without the need for EV sub-metering, for example.

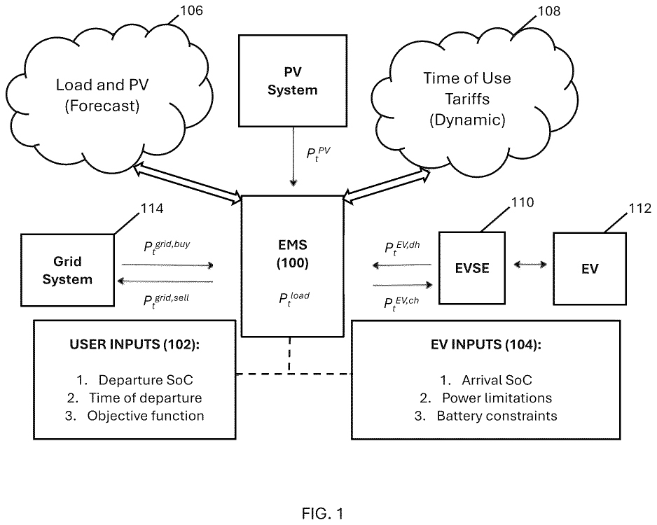

Referring to FIG. 1, the EMS 100 uses several inputs to achieve the objective function of the user for a specific charging cycle. There are two input categories: static and dynamic. Static inputs include user inputs 102, such as departure state-of-charge (SoC), time of departure, and objective function, and EV inputs 104, such as arrival SoC, power limitations, and battery constraints. Dynamic inputs include load and photovoltaic (PV) forecasts 106 and time of use tariff information 108, including energy prices and grid tariffs. Static inputs are time-invariant and serve predominantly as performance benchmarks. In contrast, dynamic inputs have a substantial influence on system functionality, influencing decision such as EV charging timing via the EV charger 110 and/or the use of the EV and EV battery 112 as an energy source. An additional input includes the buy/sell data associated with the grid 114. Currently, the home EMS and method 100 rely on assumed static values for the dynamic inputs, resulting in suboptimal system performance.

The present disclosure focuses on the dynamic prediction of the PV energy generation and the electricity consumption of the home by removing the EV charging influence, and incorporating these modified dynamic models into the home EMS system and method 100, as well as evaluating the performance of the home EMS system and method 100.

The home EMS and method 100 have separate variables for electricity consumption of the home and the PV charging cycle, as seen in equation (1) below. This also represents the formula that the home EMS system and method 100 must deal with at every prediction step.

$${P}_{t}^{load} - {P}_{t}^{PV} = {P}_{t}^{grid , buy} + {P}_{t}^{EV , dh} - {P}_{t}^{EV , ch} - {P}_{t}^{grid , sell} \qquad ( 1 )$$

The left side of equation (1) reflects forecasted inputs, while the right side of equation (1) reflects decision variables or an optimal set of variables resulting from optimization.

However, the initial dataset of the electricity consumption of the home consists of detailed collective hourly electricity readings of the EV and the home. The EV charging cycles bring notable peaks that are distinguished by their unique amplitude and frequency patterns, which is noticed when considering the standard charging cycle of an EV. The present disclosure removes these EV charging cycle distortions from the collected data in order to extract home electricity usage data. This is achieved by implementing a complex analytical signal processing procedure that includes the Hilbert-Huang Transform (HHT) and Ensemble Empirical Mode Decomposition (EEMD).

By implementing an EEMD-HHT, the present disclosure extracts the EV charging cycle without any prior knowledge of or any information about the duration of the charging cycle and/or the amount of energy that it consumes.

This problem may arise when a user changes a wall box and information about the EV charging cycle is lost, for example, or when a user does not record the electricity consumed by an EV. In a hypothetical situation, the problem arises due to lack of information about the EV charging cycle.

EEMD is an advanced signal processing technique developed to address some of the limitations of the original Empirical Mode Decomposition (EMD) method. EMD is used to decompose a signal into a set of Intrinsic Mode Functions (IMFs), which are simple oscillatory modes that represent different frequency components of an original signal. IMFs are functions that have a symmetric waveform with the same number of extrema and zero-crossings, and their mean value is close to zero. EMD is an adaptive method, making it suitable for analyzing non-linear and non-stationary signals.

EMD can suffer from mode mixing, where a single IMF may consist of signals of widely differing scales, or different IMFs may have similar scales. EEMD addresses this issue by adding white noise to the original signal. The process involves generating an ensemble of trials, each adding different white noise to the original signal, and then applying EMD to each of these noisy signals. The IMFs obtained from each trial are averaged to give the final set of IMFs, with the added noise helping to uniformly distribute the signal's energy across the different scales and reduce mode mixing.

The HHT is often used in conjunction with EEMD. HHT consists of two parts: first, the EMD or EEMD) and, second, the Hilbert spectral analysis. After decomposing the signal into IMFs using EEMD, the Hilbert Transform is applied to each IMF. This produces instantaneous frequency data as a function of time, which can be represented in a time-frequency-energy distribution known as the Hilbert Spectrum. This process is particularly effective for analyzing the frequency content of non-linear and non-stationary signals over time.

Combining EEMD and HHT provides a powerful method for signal analysis. EEMD effectively decomposes a signal into simpler components (the IMFs) that are more meaningful for analysis, while HHT provides a detailed view of how the frequencies of these components vary over time.

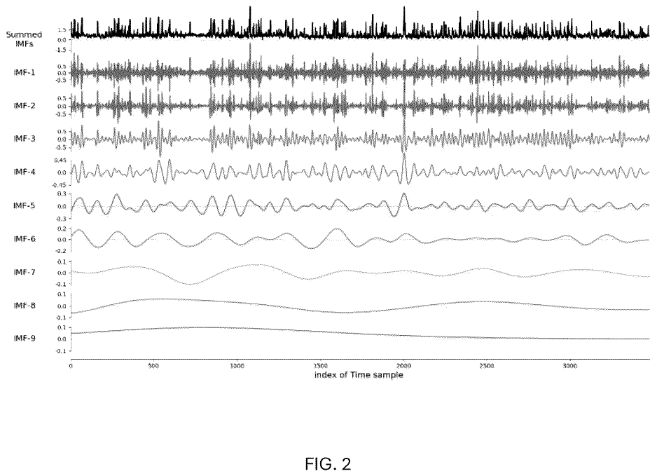

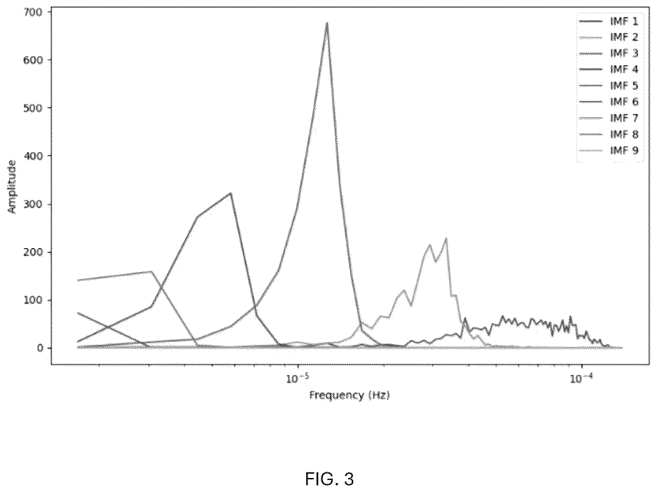

Thus, EEMD is a powerful technique for decomposing complex time series data into simpler components known as IMFs. The electricity consumption data is divided into nine distinct IMFs, for example (see FIG. 2), each representing different frequency components within the data. Following the decomposition, HHT is applied to these IMFs. HHT provides the ability to analyze the amplitude and frequency characteristics of each IMF, thereby facilitating the identification of those components most influenced by EV charging, as shown in FIG. 3.

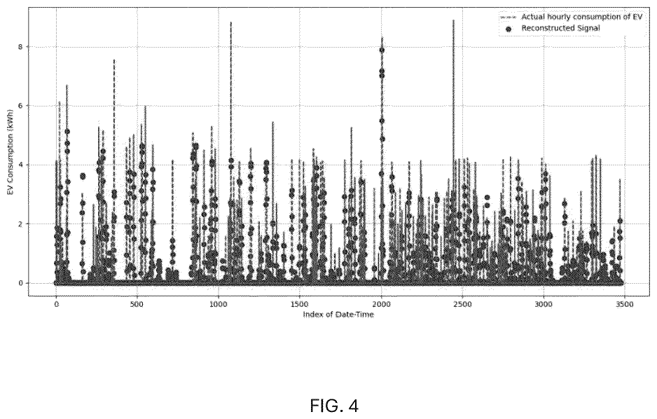

An illustrative dataset containing rough information on EV charging from Jan. 1, 2023, to Jun. 30, 2023, is collected from the same home. The dataset has the collective information of charging cycle, rather than having detailed hourly information about the charging cycle. Hence, an average is taken to derive hourly consumption values. In instances where date and time data are absent, zeros are added to ensure continuity. This results in time series data. EEMD-HHT is employed to decompose this non-linear and non-stationary time series data into its IMFs. Some IMFs may be identified as irrelevant through experimental investigation and removed, focusing the analysis on the signal that correlates with typical EV charging patterns. This process isolates the fundamental characteristics of EV charging, and the results are subsequently compared with anticipated charging profiles in FIG. 4, demonstrating the capability of EEMD in extracting important data features.

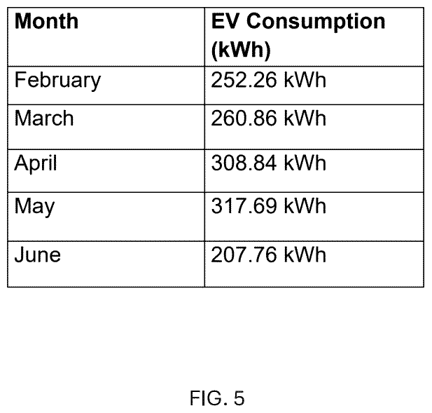

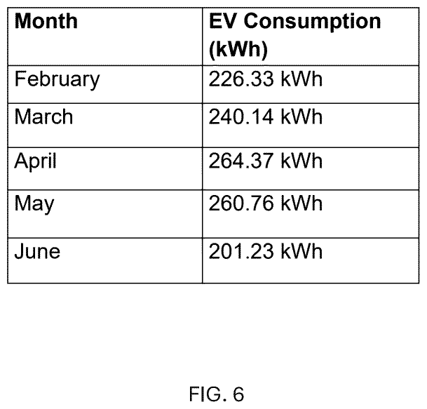

FIGS. 5 and 6 show the values of the total energy consumption of the EV and removed IMF for every month. When comparing the values, the IMFs removed are quite close to the actual values.

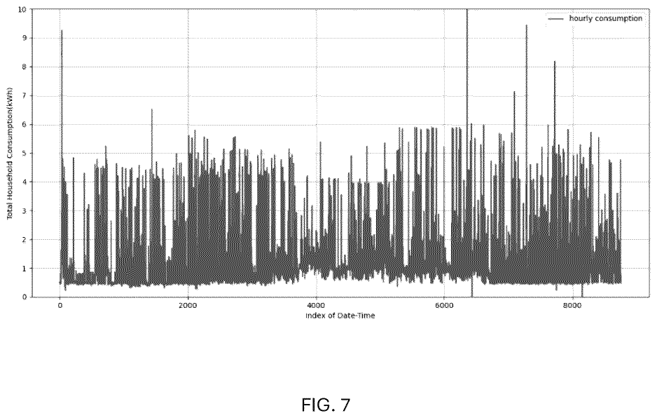

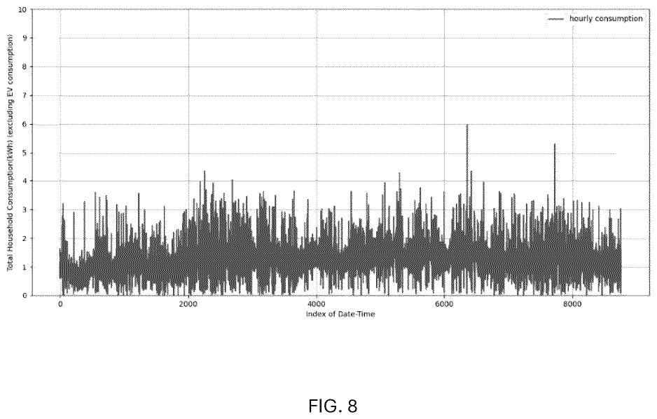

Considering this result, it can be concluded that, in an ideal scenario, EV charging cycle in the time domain can be seen as a high amplitude and low frequency signal; that is, the charging is not frequent, but it would consume large amount of electricity. After implementing this on the actual dataset of FIG. 7, the obtained dataset after removing the IMFs is shown in FIG. 8. When comparing it with the actual data available, it is noticed that there is a significant decrease in the peaks.

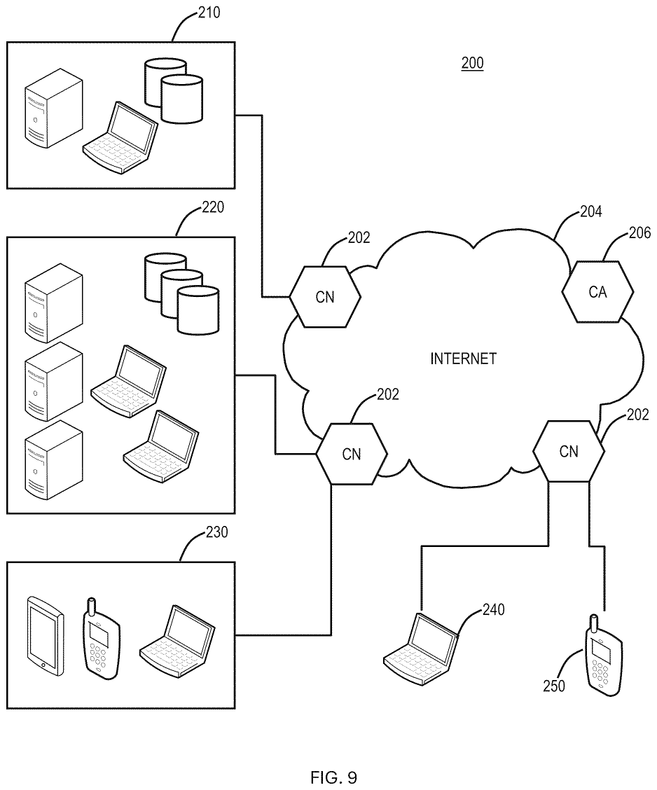

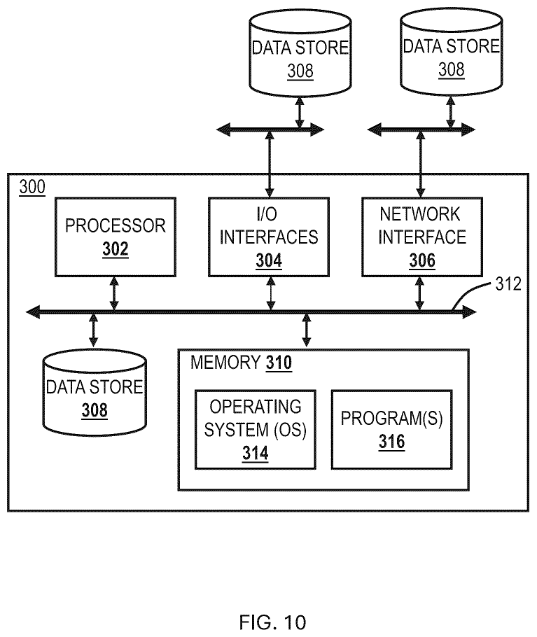

FIG. 9 is a network diagram of a cloud-based system 200 for implementing various cloud-based algorithms and functions of the present disclosure. The cloud-based system 200 includes one or more cloud nodes (CNs) 202 communicatively coupled to the Internet 204 or the like. The cloud nodes 202 may be implemented as a server 300 (as illustrated in FIG. 10) or the like and can be geographically diverse from one another, such as located at various data centers around the country or globe. Further, the cloud-based system 200 can include one or more central authority (CA) nodes 206, which similarly can be implemented as the server 300 and be connected to the CNs 202. For illustration purposes, the cloud-based system 200 can connect to a regional office 210, headquarters 220, various employee's homes 230, laptops/desktops 240, and mobile devices 250, each of which can be communicatively coupled to one of the CNs 202. These locations 210, 220, and 230, and devices 240 and 250 are shown for illustrative purposes, and those skilled in the art will recognize there are various access scenarios to the cloud-based system 200, all of which are contemplated herein. The devices 240 and 250 can be so-called road warriors, i.e., users off-site, on-the-road, etc. The cloud-based system 200 can be a private cloud, a public cloud, a combination of a private cloud and a public cloud (hybrid cloud), or the like.

The cloud-based system 200 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 210, 220, and 230 and devices 240 and 250. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 200 is replacing the conventional deployment model. The cloud-based system 200 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 200 is illustrated herein as one example embodiment of a cloud-based system, and those of ordinary skill in the art will recognize the systems and methods described herein are not necessarily limited thereby.

FIG. 10 is a block diagram of a server 300, which may be used in the cloud-based system 300 (FIG. 9), in other systems, or stand-alone, such as in a vehicle system. For example, the CNs 202 (FIG. 9) and the central authority nodes 206 (FIG. 9) may be formed as one or more of the servers 300. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 10 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example, but is not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chipset), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components.

The network interface 306 may be used to enable the server 300 to communicate on a network, such as the Internet 204 (FIG. 9). The network interface 306 may include, for example, an Ethernet card or adapter (e.g., 10BaseT, Fast Ethernet, Gigabit Ethernet, or 10GbE) or a Wireless Local Area Network (WLAN) card or adapter (e.g., 802.11a/b/g/n/ac). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300, such as, for example, an internal hard drive connected to the local interface 312 in the server 300. Additionally, in another embodiment, the data store 308 may be located external to the server 300 such as, for example, an external hard drive connected to the I/O interfaces 304 (e.g., a SCSI or USB connection). In a further embodiment, the data store 308 may be connected to the server 300 through a network, such as, for example, a network-attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

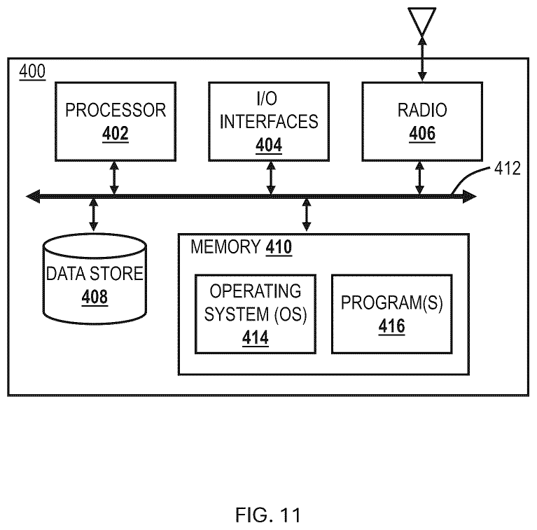

FIG. 11 is a block diagram of a user device 400, which may be used in the cloud-based system 200 (FIG. 9), as part of a network, or stand-alone, such as in a vehicle system. Again, the user device 400 can be a vehicle, a smartphone, a tablet, a smartwatch, an Internet of Things (IoT) device, a laptop, a virtual reality (VR) headset, etc. The user device 400 can be a digital device that, in terms of hardware architecture, generally includes a processor 402, I/O interfaces 404, a radio 406, a data store 408, and memory 410. It should be appreciated by those of ordinary skill in the art that FIG. 11 depicts the user device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example, but is not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a CPU, an auxiliary processor among several processors associated with the user device 400, a semiconductor-based microprocessor (in the form of a microchip or chipset), or generally any device for executing software instructions. When the user device 400 is in operation, the processor 402 is configured to execute software stored within the memory 410, to communicate data to and from the memory 410, and to generally control operations of the user device 400 pursuant to the software instructions. In an embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 406 enables wireless communication to an external access device or network. Any number of suitable wireless data communication protocols, techniques, or methodologies can be supported by the radio 306, including any protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

Again, the memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 11, the software in the memory 410 includes a suitable operating system 414 and programs 416. The operating system 414 essentially controls the execution of other computer programs and provides scheduling, input-output control, file and data management, memory management, and communication control and related services. The programs 416 may include various applications, add-ons, etc. configured to provide end user functionality with the user device 400. For example, example programs 416 may include, but not limited to, a web browser, social networking applications, streaming media applications, games, mapping and location applications, electronic mail applications, financial applications, and the like. In a typical example, the end-user typically uses one or more of the programs 416 along with a network, such as the cloud-based system 200 (FIG. 9).

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A home energy management system comprising one or more processors and one or more memories storing instructions executed by the one or more processors to
receive collective energy usage data comprising home energy usage data and electric vehicle energy usage data,
extract the electric vehicle energy usage data from the collective energy usage data to determine the home energy usage data, and
control energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of the home energy management system.

2. The home energy management system of claim 1, wherein the electric vehicle energy usage data is extracted from the collective energy usage data using Ensembled Empirical Model Decomposition.

3. The home energy management system of claim 2, wherein the electric vehicle energy usage data is further extracted from the collective energy usage data using a Hilbert-Huang Transform.

4. The home energy management system of claim 3, wherein the electric vehicle energy usage data is further extracted from the collective energy usage by decomposing a signal into a set of Intrinsic Mode Functions that are simple oscillatory modes that represent different frequency components of the signal and removing the Intrinsic Mode Functions from the collective energy usage data to determine the home energy usage data.

5. The home energy management system of claim 1, wherein the home energy management system performs energy usage predictions using the following formula:
$${P}_{t}^{load} - {P}_{t}^{P V} = {P}_{t}^{grid , buy} + {P}_{t}^{EV , dh} - {P}_{t}^{EV , ch} - {P}_{t}^{grid , sell} .$$

6. The home energy management system of claim 1, wherein the one or more processors and the one or more memories are disposed in one or more of the home energy management system, a cloud network, and a model generator for the home energy management system.

7. The home energy management system of claim 1, wherein the electric vehicle supply equipment is a bidirectional electric vehicle charger.

8. A home energy management method comprising
receiving collective energy usage data comprising home energy usage data and electric vehicle energy usage data,
extracting the electric vehicle energy usage data from the collective energy usage data to determine the home energy usage data, and
controlling energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of the home energy management system.

9. The home energy management method of claim 8, wherein the electric vehicle energy usage data is extracted from the collective energy usage data using Ensembled Empirical Model Decomposition.

10. The home energy management method of claim 9, wherein the electric vehicle energy usage data is further extracted from the collective energy usage data using a Hilbert-Huang Transform.

11. The home energy management method of claim 10, wherein the electric vehicle energy usage data is further extracted from the collective energy usage by decomposing a signal into a set of Intrinsic Mode Functions that are simple oscillatory modes that represent different frequency components of the signal and removing the Intrinsic Mode Functions from the collective energy usage data to determine the home energy usage data.

12. The home energy management method of claim 8, wherein the home energy management system performs energy usage predictions using the following formula:
$${P}_{t}^{load} - {P}_{t}^{P V} = {P}_{t}^{grid , buy} + {P}_{t}^{EV , dh} - {P}_{t}^{EV , ch} - {P}_{t}^{grid , sell} .$$

13. The home energy management method of claim 8, wherein the electric vehicle supply equipment is a bidirectional electric vehicle charger.

14. A non-transitory computer-readable medium comprising instructions stored in one or more memories storing instructions executed by the one and executed by or more processors to
receive collective energy usage data comprising home energy usage data and electric vehicle energy usage data,
extract the electric vehicle energy usage data from the collective energy usage data to determine the home energy usage data, and
control energy distribution between a home, an electric vehicle, electric vehicle supply equipment, a photovoltaic system, and a grid system responsive to the determined home energy usage data such that overall energy consumption expenses minimized and/or renewable energy self-consumption is maximized for a user of a home energy management system.

15. The non-transitory computer-readable medium of claim 14, wherein the electric vehicle energy usage data is extracted from the collective energy usage data using Ensembled Empirical Model Decomposition.

16. The non-transitory computer-readable medium of claim 15, wherein the electric vehicle energy usage data is further extracted from the collective energy usage data using a Hilbert-Huang Transform.

17. The non-transitory computer-readable medium of claim 16, wherein the electric vehicle energy usage data is further extracted from the collective energy usage by decomposing a signal into a set of Intrinsic Mode Functions that are simple oscillatory modes that represent different frequency components of the signal and removing the Intrinsic Mode Functions from the collective energy usage data to determine the home energy usage data.

18. The non-transitory computer-readable medium of claim 14, wherein the home energy management system performs energy usage predictions using the following formula:
$${P}_{t}^{load} - {P}_{t}^{P V} = {P}_{t}^{grid , buy} + {P}_{t}^{EV , dh} - {P}_{t}^{EV , ch} - {P}_{t}^{grid , sell} .$$

19. The non-transitory computer-readable medium of claim 14, wherein the one or more processors and the one or more memories are disposed in one or more of the home energy management system, a cloud network, and a model generator for the home energy management system.

20. The non-transitory computer-readable medium of claim 14, wherein the electric vehicle supply equipment is a bidirectional electric vehicle charger.
